(19) United States
(12) Patent Application Publication
(10) Pub. No.: US 2011/0049768 A1
(43) Pub. Date: Mar. 3, 2011

(54) LIQUID CRYSTAL ELASTOMERS WITH TWO-WAY SHAPE ;MEMORY EFFECT

(76) Inventors: Jinlian Hu, Hong Kong (CN); Shaojun Chen, Hong Kong (CN); Qiwei Pan, Hong Kong (CN)

(21) Appl. No.: 12/863,953

(22) PCT Filed: Jan. 21, 2008
(86) PCT No.: PCT/IB2008/000158

§ 371 Date: Oct. 26, 2010

(51) Int. Cl. B29C 35/08; C08F 220/26

(52) U.S. Cl. 264/477; 526/320; 264/184

(57) ABSTRACT

The present invention relates to liquid crystal elastomers having two-way shape memory effect and methods of making such LCEs. The method of preparation includes the steps of polymerizing at least two monomers with crosslinking polymer, prealigning the resultant polymer, crosslinking the resultant polymer, and preparing the liquid crystal elastomer. The liquid crystal elastomer can be drawn to fibers.

### BACKGROUND OF THE INVENTION

1. Field of the Invention

This invention is in the area of smart materials and smart textiles, and particularly relates to liquid crystal elastomers having two-way shape memory effect.

2. Description of the Prior Art

In the past twenty years, shape memory materials (SMMs) have drawn wide attention from scientists and engineers because they have the ability to remember the original shape at different conditions, and SMMs have great potential applications in sensors, actuators, smart devices, and media recorders. Many kinds of SMMs have been developed, for example shape memory alloys (SMAs), shape memory polymers (SMPs), and shape memory ceramics (SMCs). In particular, the SMPs have found wide industrial applications because of their easy processing, ability to form self-standing film with thickness from nanometers to centimeters, lightweight, flexibility in molecular design, and precisely controllable synthesis.

Two kinds of shape memory effect (SME) were widely observed in SMMs, e.g. one-way shape memory effect (OSME) and two-way shape memory effect (TSME). For the thermal-induced OSME, SMMs remember one permanent shape formed at a higher temperature, while they do not have any memory for temporary shapes. For thermal-induced TSME, SMMs will remember two permanent shapes, one formed at a higher temperature and one formed at a lower temperature, that is by the thermally cycling the system. Two-way SMMs will take two different shapes depending on the temperature.

Most thermally-induced SMPs only have one-way shape memory effect, but the concept of two-way shape memory effect has appeared in SMAs for a long time. In SMAs, intrinsic and extrinsic two-way shape memory effects are characterized by a shape transition both upon heating from the martensite phase to the austenite phase, as well as an additional shape transition upon cooling from the austenite phase to the martensite phase. Intrinsic two-way shape memory behavior must be induced in the shape memory material through processing. Such procedures include extreme deformation of the material while in the martensite phase, heating-cooling under constraint or load, or surface modification such as laser annealing, polishing, or shot-peening. Once the material has been trained to exhibit the two-way shape memory effects, the shape change between the low and high temperature states is generally reversible and persists through a high number of thermal cycles.

Recently, shape-changing polymers, which change their shapes as long as they are exposed to a suitable stimulus, have received wide attention due to their promising applications in artificial muscles, reversible actuators, deployable structures, such as aircraft or spacecraft, and other mechanical devices. The stimuli for shape change polymers reported include heat, light and electro-magnetic fields. For light-stimulated shape-changing polymer, shape-changes are based on photomechanical effects and light-stimulated phase transition through the responsiveness towards light by various functional groups, including azobenzene and triphenylmechane leuco derivatives. For thermally-stimulated shape-changing polymers, shape-changing effect is based on phase transitions. A typical example is the liquid crystal elastomers (LCE). On heating, as the temperature increases above the clear point (Tᵢ) of LCEs where the liquid crystal (LC) phase changes to isotropic phase, it can be observed that the shape changes to a higher temperature shape; on cooling, as the temperature decreases to below the Tᵢ of LCEs where the isotropic phase enters into LC phase again, then the shape recovers its low temperature shape again. Scientists have named these special materials as shape-changing polymers (Marc Behl et al. 2007). This special shape changing behavior is a reversible shape memory effect which can remember at least two permanent shapes, one generated at lower temperature and one generated at higher temperature. Two-way shape memory effect is introduced here to describe this reversible shape-changing behavior.

In 1975, de Gennes had predicted that LC phase transition of liquid crystal materials could lead to mechanical stress or strain. The phase transition induced stress leads to static forces, which are balanced by flow in conventional liquid crystals, but the free flow is prevented through polymer network formation in LCEs. In these LCEs, the liquid crystal moieties are bound to a flexible, cross-linked polymer backbone. This polymer backbone allows a change of the orientation of the mesogens, but not a free flow. The change of orientation can be stimulated thermally or by application of an electromaganetic field. Therefore, the induced stresses are transformed from the mesogen to the polymer backbone and result in mechanical work. LCEs are unique because they combine the anisotropic aspects of the LC phases and the elasticity of polymer networks. Several unusual physical effects have been discovered in LCEs, such as spontaneous “soft elasticity”. Therefore, LCEs have been developed into excellent smart materials as two-way shape memory polymers.

In liquid crystal polymers, the monomers can be attached together in essentially two ways. The liquid crystal part or mesogenic unit of the polymer may be part of the polymer backbone resulting in a main chain polymer, alternatively the mesogenic unit may be attached to the polymer backbone as a pendant group i.e. extending away form the polymer backbone; this results in a side-chain polymer. For side-chain liquid crystal polymers, according to Finkelmann et al., if mesogenic groups are directly attached to the polymer backbone, thermal motions of the polymer segments and mesogenic groups are directly coupled. When the temperature is above the T_{g}, the polymer tends to adopt statistical chain conformations that hinder the anisotropic orientation of the mesogenic groups. Therefore, flexible spacers should be inserted between the backbone and mesogenic units to decouple their interactions. In such conditions, the mesogenic side chains can be anisotropically ordered in the liquid crystal state even though the polymer main chains tend to adopt the statically random coil conformations. This idea has been proven by many experiments and has become a useful guide for molecular design of side-chain liquid crystal polymer. Different from the above model, mesogen-jacketed liquid crystal polymers (MJLCPs) proposed by Zhou et al. form a different class of side chain liquid crystal polymers. In MJLCPs, the rodlike mesogenic units are connected at their gravity center (or a nearby position) to the main chain through no or only very short spacers. It has been proven that in this case the introduction of the flexible spacers to decouple the interactions of the main chain and the mesogenic unit side group is not necessary for the polymer to form liquid crystal phase. However, the rigid mesogenic units are believed to be essential for these two classes of side-chain type polymers to form a liquid crystal phase, although in some cases the mesogenic group itself cannot form a stable liquid crystal phase.

From a reaction point of view, usually, there are two basic approaches to prepare LCEs: the first approach developed by Mitchell and co-workers involved cross-linking of an acrylate polymer prealigned in a magnetic field. The second method proposed by Finkelmann and co-workers involved a two-step cross-linking strategy of a siloxane liquid crystal polymer. The first stage involved a lightly cross-linking of the polymer while applying a stress field. Subsequently, a second cross-linking reaction was performed which fixed of large dimensions with permanent alignment, and highly anisotropic mechanical properties were produced. An alternative approach to produce intermolecular cross-linking was photo cross-linking.

Potential applications for shape-memory polymers exist in almost any area of daily life. Especially, in the textiles area, the emergence of one-way shape memory fibers has led to the development of new textiles having sensing, adapting and reacting capabilities. Thus, the two-way shape memory fibers or fabrics will endow the textiles with more smart function.

It is therefore an object of the present invention to provide LCEs having two-way shape memory effect.

It is still another object of the present invention to provide the preparation of two-way shape memory fibers.

It is an object of the present invention to overcome the disadvantages and problems in the prior art.

### SUMMARY OF THE INVENTION

Polymers having two-way shape memory effect, articles of manufacture thereof, and fibers having two-way shape memory effect and methods of preparation are described herein. In one embodiment, the polymer and fiber therefrom have the ability to remember two permanent shapes. Especially by changing the temperature, the two-way shape memory polymers change its shape in the direction of permanent shape 1 or permanent shape 2.

In one preferred form, the two-way shape memory polymers are liquid crystal elastomers. They can be prepared into films/strips, and spun into fibers, but not limited to these forms.

In one preferred form, the liquid crystal elastomers has a typical phase transition between LC phase and isotropic phase, including nematic LC phase to isotropic (N-I) phase transition and smetic LC phase to isotropic (S-I) phase transition.

In one preferred form, the liquid crystal elastomers can be the main-chain liquid crystal polymer which the mesogenic units are part of the backbone, or the side-chain liquid crystal polymer. For the side-chain LCEs, it can be the conventional side-chain liquid crystal polymers as the Finkelmann's model, or it can be MJLCPs as the Zhou's model.

In one preferred form, liquid crystal polymer can be synthesized by the radical polymerization method, and living polymerization method. The LCEs can be made from a striated structure based on the lamellar phase of triblcok copolymer and made from other polydomain structure, but not limited to these.

In still another alternative preferred form, the invention comprises a method of preparation LCEs and fiber thereof having two-way shape memory effect.

In still another alternative preferred form, the LCEs or fibers can be prepared through the following methods: the first approach involves cross-linking of polyacrylate prealigned in a magnetic field; the second approach involves a two-step cross-linking in a stress fields. It also can be prepared with a mixture method of the two approaches, but not limited to these.

In still another alternative preferred form, the fibers having two-way shape memory effect can be spun by wet spinning method, melt spinning method, and electrospinning method, but not limited thereto.

Further areas of applicability of the present invention will become apparent from the present description. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawing, wherein:

FIG. 1 is the illustration of two typical shape memory effect: one-shape memory effect (OSME) (101(a)) and two-shape memory effect (TSME) (101(b));

FIG. 2 is an illustration of phase transition in liquid crystal elastomers (LCEs);

FIG. 3 is an embodiment of a process for manufacturing the present LCEs;

FIG. 4 are embodiments of main-chain LCEs and side chain LCES; and

FIG. 5 is an embodiment for wet-spinning preparation method for the present LCE fibers.

### DETAILED DESCRIPTION OF THE INVENTION

The following description of the invention is in no way intended to limit the invention, its application, or use. The present disclosure introduces the two-way shape memory LCEs and provides the method of preparation of two-way shape memory LCEs and fibers thereof.

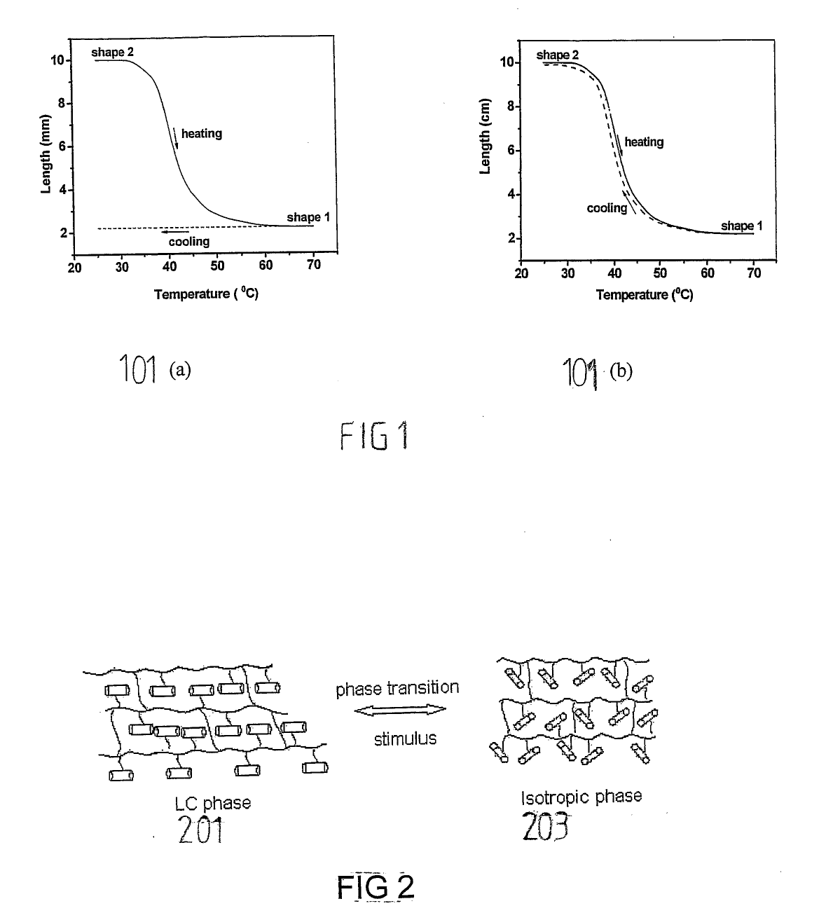

Referring to FIG. 1, it shows the difference of TSME (101(a)) and OSME (101(b)). Generally, the one-way SMMs can only remember one shape. That is, when the shape is deformed to a second shape at higher temperature or lower temperature with an external force; the second shape can be fixed after it cools to low temperature and recover its original shape after reheating to the higher temperature. But it cannot elongate itself without external force. The thermo-mechanical procedure discontinues after one cyclic. In comparison, two-way SMMs can remember two permanent shapes, one formed at higher temperature and one formed at lower temperature. By thermally cycling the system, these types of polymeric materials will take two different shapes depending on the temperature. Shape 1 changes to Shape 2 when it increases to higher temperature and the Shape 2 changes to Shape 1 after it cools to a lower temperature. This is a continuous thermo-mechanical procedure. The present invention describes those polymers having two-way shape memory effect, called two-way shape memory polymers (TWSMPs).

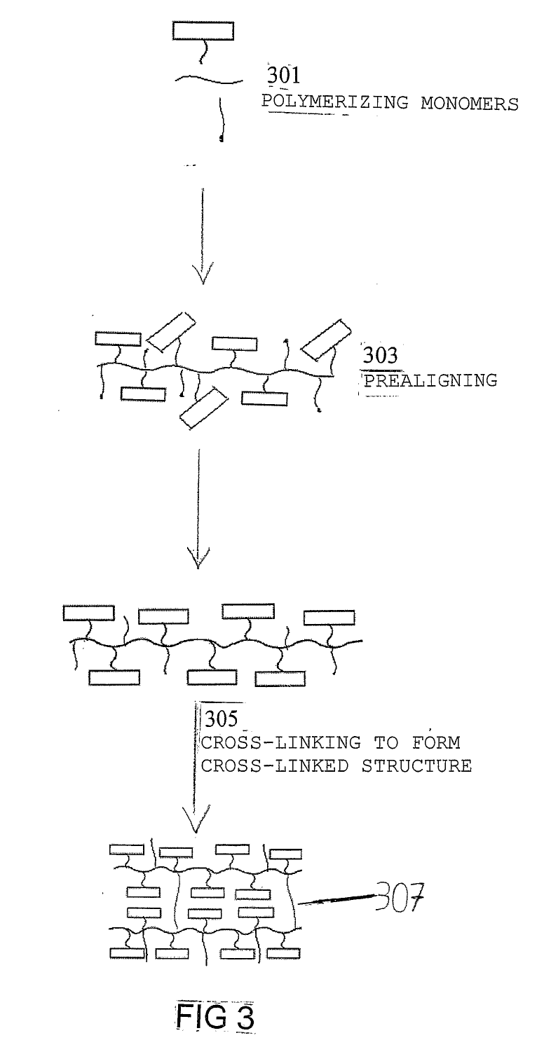

The TWSMPs introduced herein are LCEs. As shown in FIG. 2, for the two-way LCEs, it is necessary that phase transition can be performed between liquid crystal (LC) phase 201 and isotropic phase 203. In the LC phase, the mesogenic unit aligns along the molecular chain to form the LC phase. Then, the macro-shape of LCEs extends to a long aligned shape. However, when the temperature increases to above Tₙᵢ or Tₛᵢ, the LCEs enters into the isotropic phase when the molecular chain is coiled. Then the macro-shape recovers to a short length shape. On the contrary, when the temperature decreases, the morphology of LCEs enters into LC phase from isotropic phase, then the mesogenic units align along the backbone, and the macro-shape expands to a long length shape. Thus, the uniaxial contraction-expansion can be achieved through the reversible through the reversible phase transition between LC phase with transition phase.

The present invention also includes methods of manufacturing the present LCEs. FIG. 3 shows such method, wherein the monomers are polymerized with other cross-linking monomers 301. In this step, the functional group for the following cross-linking is grafted on the molecular chain. Then, a prealigning process is performed in the magnetic field or, alternatively, a stress field 303. In this step, the mesogenic units are aligned to form an orientation structure, and an LC phase can be formed by controlling the temperature. A cross-linking step is applied to form a cross-linked structure 305. In this last step, the liquid crystal elastomer containing reversible phase transition of anisotropic to isotropic phase is prepared 307. Referring to the polymerization method, various methods can be used including traditional radical polymerization method, living polymerization method such as atom transfer radical polymerization method (ATRP) and reversible addition fragmentation chain transfer polymerization (RAFT), for preparing triblock LCEs which forms striated structure based on the lamellar phase of a triblock copolymer.

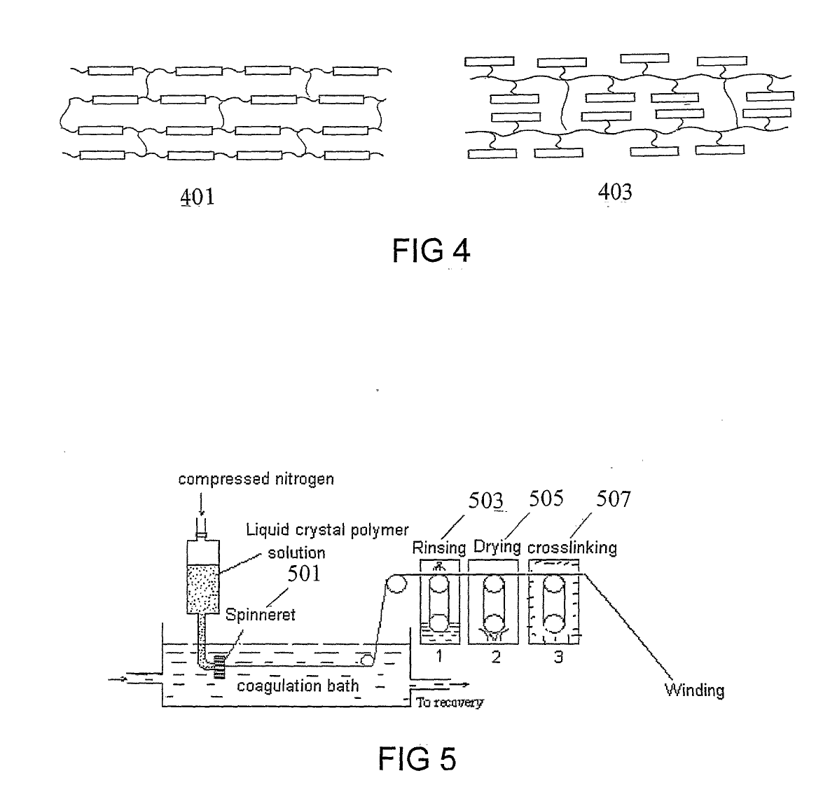

Referring to the FIG. 4, there are two kinds of LCEs, e.g. main-chain LCEs (401) and side chain LCEs (403). As shown, when mesogenic units are part of the polymer backbone, resulting in a main-chain LCEs. Alternatively, the mesogenic unit may be attached to the polymer backbone as a pendant group, it results in side-chain LCEs. It is anisotropic, rigid section of the mesogenic units that displays orientational order in the liquid crystal phases. In order to affect the phases exhibited by the liquid crystal and the subsequent optical properties there are many features which can be altered, some of these features are particularly pertinent to side-chain liquid crystal polymers. One of these features is the flexible part that joins the mesogenic unit to the polymer backbone which is generally referred to as a spacer; the length of this spacer can be altered and its flexibility can also be altered. A number of side-chain liquid crystal polymers are known, for example GB2146787A, incorporated herein by reference.

It becomes a basic principle for LCEs having two-way shape memory effect that the LCEs have a typical phase transition between anisotropic phase and isotropic phase. Therefore, the monomer plays a key role to determine the two-way shape memory effect. For the side-chain LCEs' monomer, it can be divided into two types. As mentioned above, in the Finkelmann model, a spacer is needed between the backbone and mesogenic unit for its LCEs to have an anisotropic phase to isotropic phase transition. However, in the MJLCPs, some special monomers with short spacer also can be used to synthesize liquid crystal polymer; the phase transition from LC phase to isotropic phase is also observed. Therefore, the present invention is not limited to the spacer selection of monomer. The selection of monomer is to aim to synthesize LCEs showing phase transition of LC phase to isotropic phase depending on temperature.

Referring to FIG. 5, a fiber manufacturing process is presented herewith. Because the LCEs have a crosslinked structure, liquid crystal polymer containing crosslinking agent should be drawn into fiber before crosslinking during either wet-spinning or melting-spinning process. For example, in wet-spinning, liquid crystal polymer solution are spun into fiber through a coagulation bath 501. Then it is rinsed (503) and dried (505) by two ovens. During this process, the fiber can be subjected to stress field for orientation. Under the stress field, the mesogenic unit is also aligned along the molecular chain. After that, the prealigned fiber passes through a third oven, and the crosslinking agent existing in the fiber can chemically crosslink functional groups under heat or UV light radiation (507). At last, the crosslinking structure can be achieved in the prealigned fiber. Two-way LCEs fiber can be prepared in this way. But the present invention is not limited to the wet-spinning method. Melt spinning method can be used to prepare this kind of fiber.

The present invention will be further understood with reference to the following examples, but not limited thereto.

### EXAMPLE

To demonstrate the method of the present invention, a manufacture process of side-chain nematic LCEs is provided herein.

Two acrylate type monomers M1, M2 are prepared for the following preparation of LCEs according to methods known in the literature

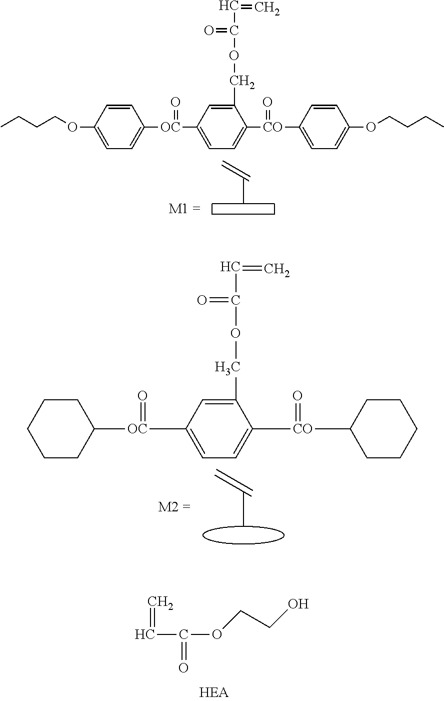

### Monomers

In one example, the mesogenic monomer M1 is mixed with HEA at a 1:1 mol ratio for the preparation of aligned LCEs. Then the mixture is polymerized into prepolymer of LCEs under the condition of AIBN at 80° C. after 24 hours as the synthesis scheme below:

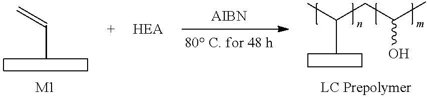

In another example, a mixture of two mesogenic monomer M1 and M2 at a 45/45 mol % ratio is used with 10 mol % hydroxylethyl acrylate (HEA) for the preparation of aligned LCEs. At first, the mixture is polymerized into prepolymer of LCEs under the condition of AIBN at 80° C. after 24 hours as the below synthesis scheme:

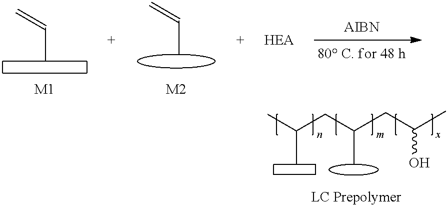

### Synthesis Scheme of LC Prepolymer

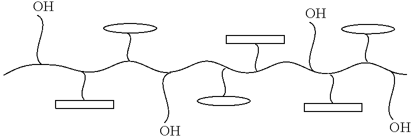

### Prepolymer of LCEs Copolymer

In the prepolymer of LCEs copolymer, it retains a hydroxyl (—OH) group which can react with MDI easily for the following crosslinking step:

For preparing two-way shape memory films or strips, the prepolymer will mix the liquefied MDI directly before putting on the Teflon mould. Then put in a 1.8 T magnetic field for about 12 h at room temperature where the mesogenic unit in the sample will align along the backbone. After that, the mixtures will crosslink by increasing the temperature to 80° C. for 12 h. Then the two-way shape memory LCEs film can be achieved.

For preparing the two-way shape memory fiber, firstly the prepolymer will be dissolved into DMF to form solution firstly. With the prepared liquid crystal prepolymer solution, by the wet-spinning equipment, a prealigned fiber where the mesogenic units form orientation structure containing unreacted liquefied MDI can be prepared at room temperature. In the crosslinking step, the existing MDI will react with —OH group of prepolymer. Then the alignment mesogenic units are fixed in the fiber. After 12 h reaction at 100° C., the LCEs fiber can be achieved. In this way, two-way shape memory LCEs fibers are prepared.

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims.

In interpreting the appended claims, it should be understood that:

a) the word “comprising” does not exclude the presence of other elements or acts than those listed in the given claim;

b) the word “a” or “an” preceding an element does not exclude the presence of a plurality of such elements;

c) any reference signs in the claims do not limit their scope;

d) any of the disclosed devices or portions thereof may be combined together or separated into further portions unless specifically stated otherwise; and

e) no specific sequence of acts or steps is intended to be required unless specifically indicated.

1. A method of preparing a two-way shape memory liquid crystal elastomer, characterized by
polymerizing at least one liquid crystal monomer with crosslinking monomers (301);
prealigning the resultant polymer (303);
crosslinking said resultant polymer (305); and
preparing a liquid crystal elastomer (307).

2. The method of preparing a two-way shape memory liquid crystal elastomer of claim 1, wherein polymerizing said monomer with crosslinking monomers further characterized in that the functional monomer is grafted on the molecular chain.

3. The method of preparing a two-way shape memory liquid crystal elastomer of claim 1, wherein said prealigning occurs in a magnetic field, a stress field, or an electric field.

4. The method of preparing a two-way shape memory liquid crystal elastomer of claim 3, wherein preligning is further characterized by the mesogenic units are aligned to form an orientation structure and an liquid crystal phase formed.

5. The method of preparing a two-way shape memory liquid crystal elastomer of claim 1, wherein preparing said liquid crystal elastomer occurs via polymerization selected from the group consisting of radical polymerization or grafted polymerization.

6. The method of preparing a two-way shape memory liquid crystal elastomer of claim 5, wherein radical polymerization is selected from the group consisting of traditional radical polymerization, AIBN radical polymerization, living polymerization, atom transfer radical polymerization, and reversible addition fragmentation chain transfer.

7. A method of manufacturing liquid crystal elastomer fiber having two-shape memory effect, characterized in that
spinning a liquid crystal polymer solution into fiber (501);
rinsing said fiber (503);
drying said resultant fiber (505); and
crosslinking said fiber (507).

8. The method of manufacturing liquid crystal elastomer fiber having two-shape memory effect in claim 7, wherein spinning said liquid crystal polymer can occur by wet spinning, melt spinning, or electrospinning.

9. The method of manufacturing liquid crystal elastomer fiber having two-way shape memory effect in claim 7, further characterized by subjecting the fiber to stress field.

10. The method of manufacturing liquid crystal elastomer fiber having two-shape memory effect in claim 7, wherein crosslinking said fiber is cross linked under heat or UV light radiation.
